(19) United States
(12) Patent Application Publication
(10) Pub. No.: US 2016/0380356 A1
(43) Pub. Date: Dec. 29, 2016

(54) SUPER ULTRA WIDEBAND ANTENNA

(71) Applicant: Intel Corporation, Santa Clara, CA (US)

(72) Inventors: Jayprakash Thakur, Bangalore (IN); Praveen Kumar, India (IN)

(21) Appl. No.: 15/156,961

(22) Filed: May 17, 2016

(30) Foreign Application Priority Data
Jun. 26, 2015 (IN) 3213/CHE/2015

(51) Int. Cl. H01Q 9/04; H01Q 1/36; H01Q 1/24; H01Q 1/48

(52) U.S. Cl. CPC H01Q 9/0442; H01Q 1/48; H01Q 1/36; H01Q 1/243

(57) ABSTRACT

An antenna having a radiator, a ground plane, and a stub configured to couple the radiator to the ground plane. The radiator may have nested radiators. The antenna covers frequency bands in a range of approximately 680 MHz to approximately 20 GHz. Lower and higher operational frequencies of the antenna may be varied by adjusting the physical parameters of the antenna, such as length and width of the radiator, gaps between the nested radiators, number of nested radiators, ground plane size, and stub size.

### TECHNICAL FIELD

The present disclosure relates generally to an antenna, and more specifically, to a compact super ultra wideband antenna covering a wide range of frequencies.

### BACKGROUND

Wireless connectivity demand is increasing in the fields of telephony, home automation, computer peripherals, networking, point-to-point communication, wireless gaming devices and various other fields. None of the existing compact antennas cover all of the applicable bands, that is, frequencies in a range of approximately 680 MHz to 20 GHz.

### BRIEF DESCRIPTION OF THE DRAWINGS

FIGS. 1A-1D are schematic diagrams illustrating an antenna having a nested pentagon-shaped radiator, a stub, and a horizontal ground plane.

FIG. 2 is a schematic diagram illustrating an antenna having a single pentagon-shaped radiator, a stub, and a horizontal ground plane.

FIG. 3 is a schematic diagram illustrating an antenna having a nested pentagon-shaped radiator, a stub, and a slotted horizontal ground plane.

FIG. 4 is a schematic diagram illustrating an antenna having a nested pentagon-shaped radiator, a stub, and a vertical ground plane.

FIG. 5 is a schematic diagram illustrating an antenna having a nested pentagon-shaped radiator, a stub, and a vertical ground plane with reduced size as compared with FIG. 4.

FIG. 6 is a schematic diagram illustrating an antenna having a nested pentagon-shaped radiator, a stub, and a folded vertical ground plane.

FIG. 7 is a schematic diagram illustrating a wireless communication device.

FIG. 8 is a graph illustrating return loss of various radii of an antenna stub.

FIG. 9 is a graph illustrating return loss of various antenna ground planes.

FIG. 10 is a graph illustrating return loss of a number of a various number of nested pentagons of an antenna radiator.

FIG. 11 is a graph illustrating gain of various antenna configurations.

FIG. 12 is a graph illustrating efficiency of various antenna ground planes.

FIG. 13 is a flowchart illustrating a method 1300 of forming an antenna.

### DETAILED DESCRIPTION

The present disclosure is directed to a compact super ultra wide band antenna having a radiator, a stub, and a ground plane. The antenna covers super ultra wide frequency bands in a range of about 680 MHz to about 20 GHz. Lower and higher operational frequencies of the antenna may be varied by adjusting the physical parameters of the antenna, such as length and width of the radiator arms, gaps between the pentagons, number of pentagons, ground plane size, and stub size.

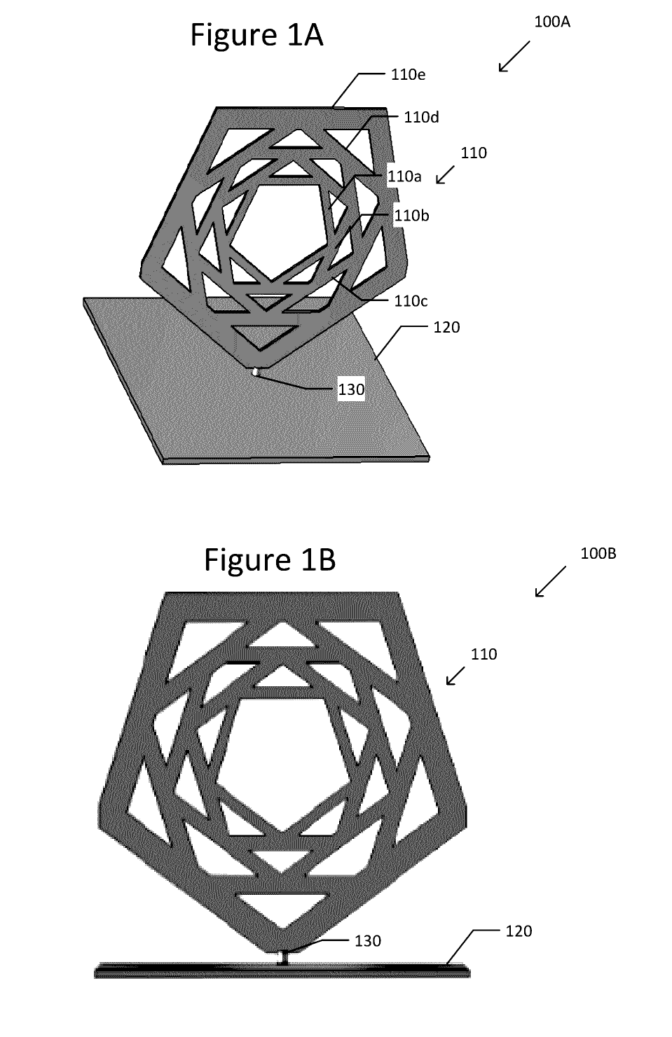

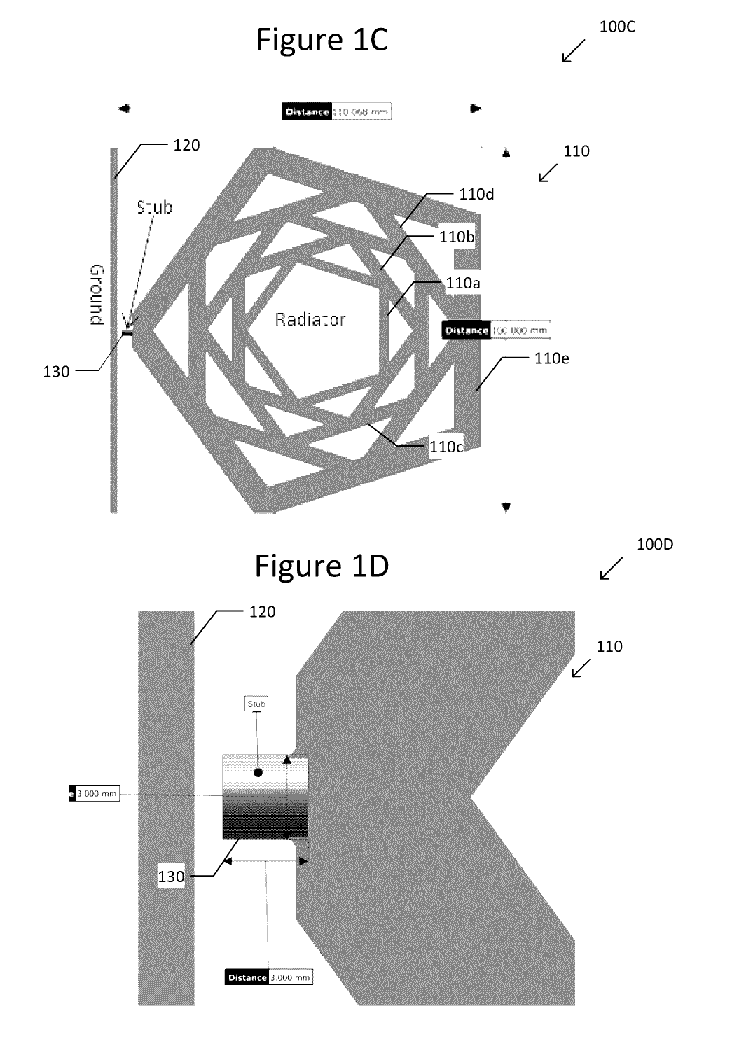

FIGS. 1A-1D are schematic diagrams illustrating an antenna 100 in accordance with an exemplary aspect.

FIG. 1A is a perspective view schematic diagram illustrating the antenna 100, and FIG. 1B is a schematic diagram 100B illustrating an alternative view of the antenna 100.

The antenna 100 comprises a radiator 110, a ground plane 20, and a stub 130. The radiator 110 shown is a pentagon-shaped radiator having a plurality of nested pentagon-shaped radiators 110a, 110b, 110c, 110d, 110e. There are five nested pentagon-shaped radiators shown, but there may be any number of radiators as suitable for the intended purpose. Also, the radiator 110 is shown as being substantially pentagon-shaped, but may be substantially square, rectangular, circular, hexagonal, or any other shape suitable for the intended purpose. The radiator 110 may be comprised of a metal, such as copper or aluminum or any other metal suitable for the intended purpose. Also, the radiator 110 may be formed on a Printed Circuit Board (PCB).

The ground plane 20 may be substantially square in shape. Alternatively, the ground plane may be substantially rectangular, or any other shape suitable for the intended purpose. The ground plane 20 may be modified to reduce the antenna size and increase the application range. The ground plane 20 shown is a horizontal ground plane, and the radiator 110 is a vertical radiator. In other words, the ground plane 20 is positioned to be at a right angle with respect to the radiator 110. Also, the ground plane 20 may be comprised of a metal, such as copper or aluminum or any other metal suitable for the intended purpose. Also, the ground plane 20 may be formed on a PCB.

The stub 130 is configured to couple the radiator 110 to the ground plane 20. The impedance of stub 130 may be matched to each of the radiator 110 and the ground plane 20 so as to maximize power transfer and minimize signal reflection. Also, the stub 130 may be comprised of a metal, such as copper or aluminum or any other metal suitable for the intended purpose. Also, the stub 130 may be formed on a PCB.

FIG. 1C is a schematic diagram 100C illustrating dimensions of the nested pentagon-shaped radiator 110. The outer pentagon 110e of the nested pentagon-shaped radiator 110 is has a size of about 100 mm×about 100 mm. The dimensions of the radiator 110 are not limited in this respect, but may be any dimensions as suitable for the intended purpose.

FIG. 1D is a schematic diagram 100D having a partial view of the antenna 100, focusing on the stub 130. The stub 130 is cylindrical in shape and has a size of about 3 mm in diameter and about 3 mm in height. The shape and dimension of the stub 130 are not limited in these respects, but may be any shape and dimension as suitable for the intended purpose.

The antenna 100 may have a frequency operating range from about 680 MHz to about 20 GHz. Lower and higher operational frequencies of the antenna 100 may be varied by adjusting the physical parameters of the antenna 100, such as length and width of the radiator 110, gaps between the nested pentagons of the radiator, the number of pentagons, the size of the ground plane 20, and the size of the stub 130.

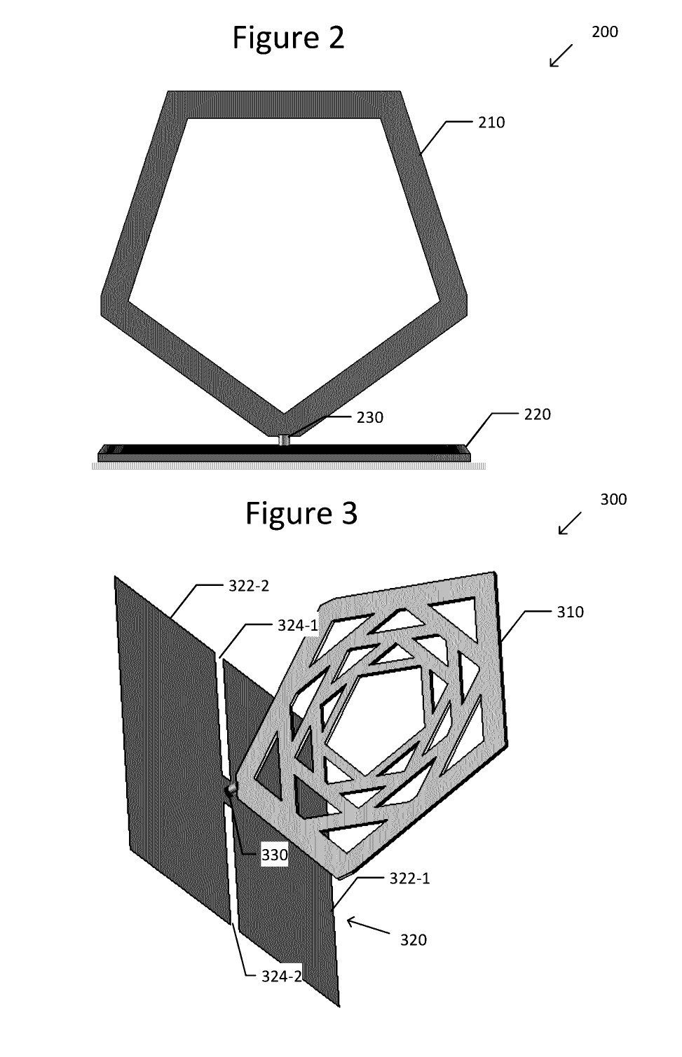

FIG. 2 is a schematic diagram illustrating an antenna 200 having a pentagon-shaped radiator 210, a ground plane 200, and a stub 230.

Antenna 200 is similar to antenna 100 of FIGS. 1A-D, except that the radiator 210 has a single pentagon, as opposed to a plurality of nested pentagons.

FIG. 3 is a schematic diagram illustrating an antenna 300 having a nested pentagon radiator 210, a ground plane 320, and a stub 330.

Antenna 300 is similar to antenna 100 of FIGS. 1A-D, except that the ground plane 220 is a slotted ground plane. The ground plane 320 has two slots 324-1, 324-2 to divide the ground plane 320 into a first section 322-1 and a second section 322-2. The ground plane 320 may be square, rectangular, or any other shape suitable for the intended purpose. Also the ground plate 320 may have any number of slots 324 as suitable for the intended purpose. The radiator 310 is shown as having nested pentagons, but the radiator 310 may alternatively have a single pentagon, or have any number of nested pentagons.

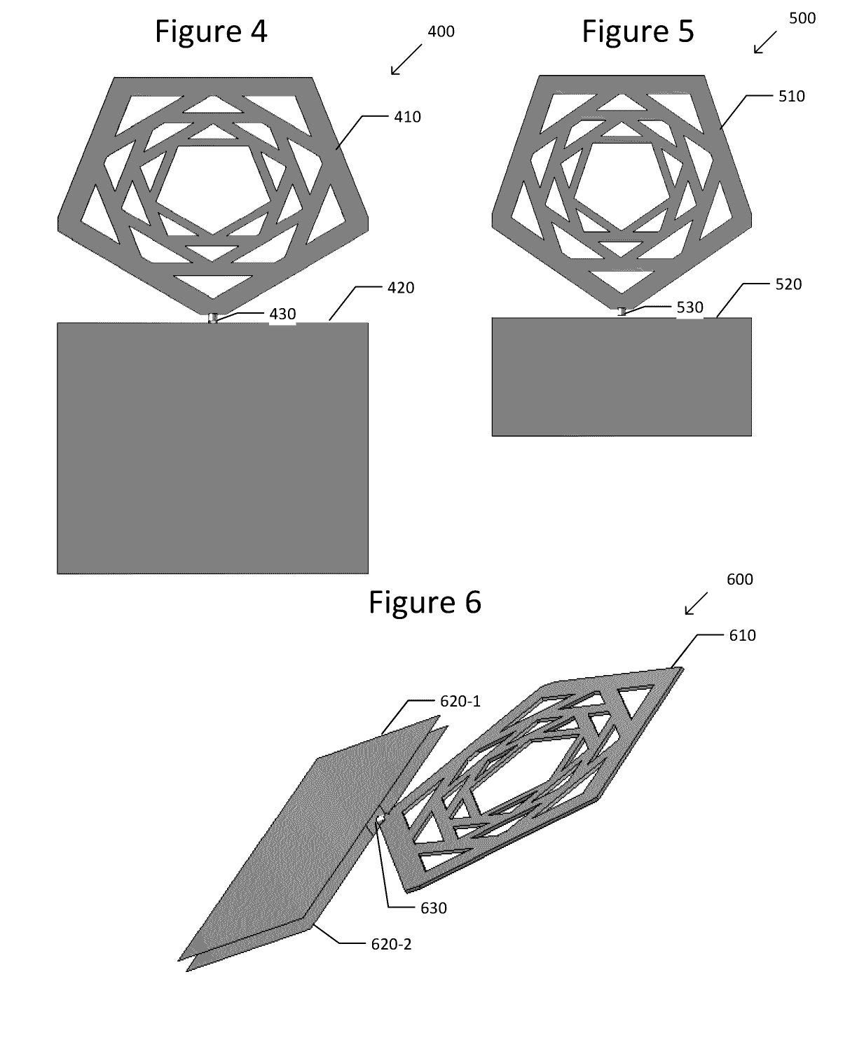

FIG. 4 is a schematic diagram illustrating an antenna 400 having a radiator 410, a ground plane 420, and a stub 430.

Antenna 400 is similar to antenna 100 of FIGS. 1A-D, except that the ground plane 420 is a vertical ground plane. In other words, the radiator 410 and the ground plane 420 are arranged in a same plane. The radiator 410 is shown as having nested pentagons, but the radiator 410 may alternatively have a single pentagon, or have any number of nested pentagons. Also, the ground plane 420 and the radiator 410 are shown as having substantially the same diameter.

FIG. 5 is a schematic diagram illustrating an antenna 500 having a radiator 510, a ground plane 520, and a stub 530.

Antenna 500 is similar to antenna 400 of FIG. 4, except that the ground plane 520 has a reduced size as compared with the ground plane 420 FIG. 4. The ground plane 520 is rectangular in shape, and the smaller side of the rectangular ground plane 520 has a length that is less than the diameter of the radiator 510. Alternatively, the ground plane 520 may be substantially rectangular in shape, and have a side with a length that is more than the diameter of the 510.

FIG. 6 is a schematic diagram illustrating an antenna 600 having a radiator 610 and a ground plane 620, and a stub 630.

Antenna 600 is similar to antenna 500 of FIG. 5, except that the ground plane 620 is a folded ground plane 620. The ground plane 62—may be formed by forming a flat plate, and then folding the plate in half. The radiator 610 is shown as having nested pentagons, but the radiator 610 may alternatively have a single pentagon, or have any number of nested pentagons.

The radiators are shown in each of the embodiments as being substantially pentagon-shaped, but may be substantially square, rectangular, circular, hexagonal, or any other shape suitable for the intended purpose.

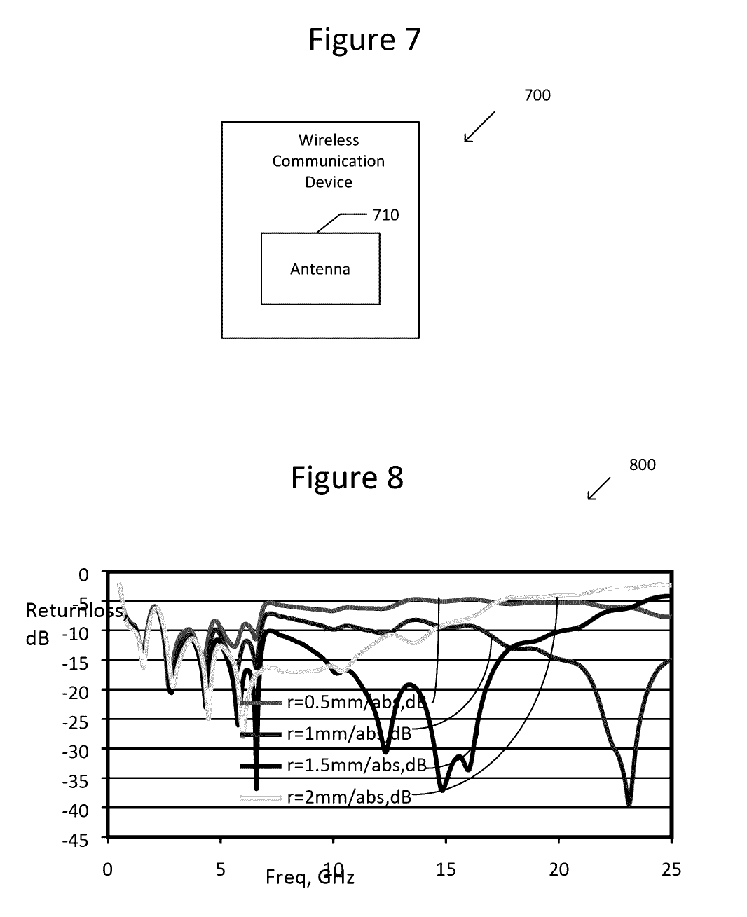

FIG. 7 is a schematic diagram illustrating a wireless communication device 700 comprising an antenna 710, which may be any of the antennas 100, 200, 300, 400, 500, and 600 shown in FIGS. 1, 2, 3, 4, 5,and 6, respectively.

The wireless communication device 700 has numerous applications. For example, the wireless communication device 700 may be used for picocell, microcell, femtocell, cellular gateways, a Long Term Evolution (LTE) network access point, an all-band indoor coverage solution, Global Positioning System (GPS) tracking, Wi-Fi router, ZigBee, a Wireless Local Area Network (WLAN), a Wide Area Network (WAN), a Personal Area Network (PAN), and/or home automation using cellular, Wi-Fi, ZigBee and Ultra Wide Band (UWB) networks. The antenna can also be used with advanced UWB systems such as wireless docking systems and wireless Universal Serial Bus (USB). Also, the antenna may be used in Microwave Impulse Radar (MIR) for landmine detestation and identification while having connectivity to GPS and cellular radios.

Further, this antenna has the flexibility for being used as ceiling mount as a part of indoor coverage solution or table mount as the part of router.

The antenna can also be used as a standard antenna for radio frequency instrument calibration, development and testing up to about 20 GHz. It can also be used to establish communication between the test equipment for Over The Air (OTA), Specific Absorption Rate (SAR), Electromagnetic Interference (EMI)/Radiation Emissions (RE)/Radiated Spurious Emissions (RSE) testing.

FIG. 8 is a graph 800 illustrating the return loss of various radii of an antenna stub. More specifically, graph 800 illustrates return loss versus frequency for antennas having a stub with radii of 0.5 mm, 1 mm, 1.5 mm, and 2 mm, respectively. Stub dimension is important to achieve a super ultra wide frequency band, and is particularly important at higher frequencies.

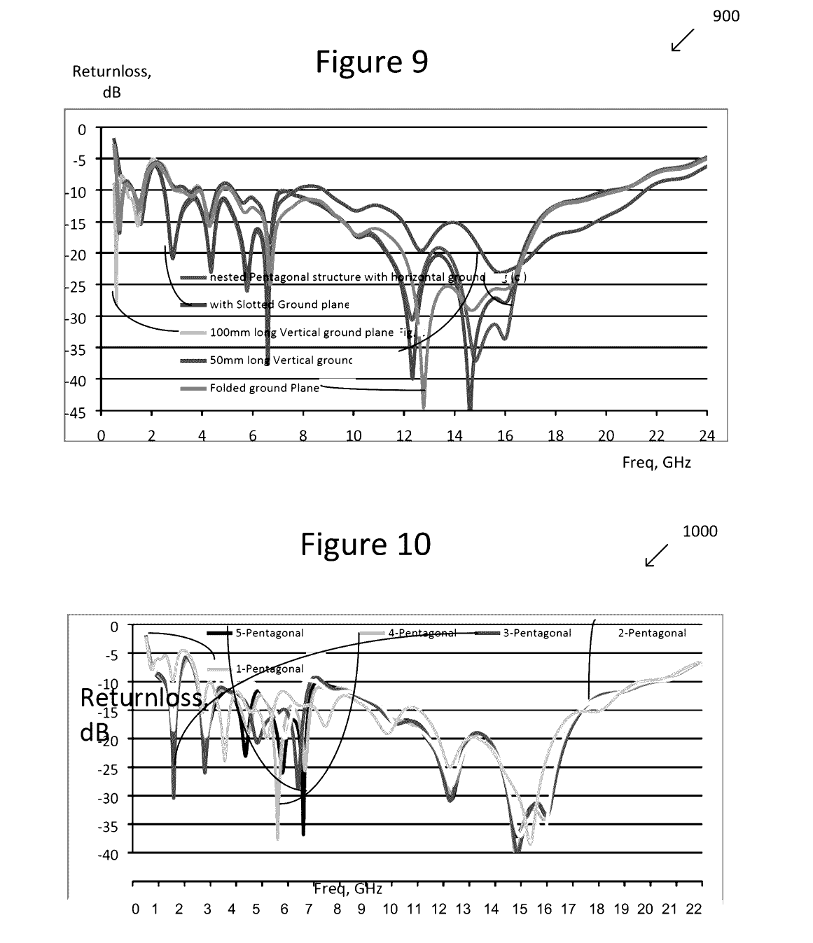

FIG. 9 is a graph 900 illustrating the return loss of various antenna ground planes. More specifically, graph 900 illustrates return loss versus frequency for antennas having a nested-pentagon radiator with various ground planes. The ground planes include horizontal ground plane 20 (FIG. 1B), slotted ground plane 320 (FIG. 3), about 100 mm vertical ground plane 420 (FIG. 4), about 50 mm vertical ground plane 520 (FIG. 5), and folded ground plane 620 (FIG. 6). It can be seen from the figure that the ground plane modifications have negligible impact on the frequency bandwidth of the antenna. As a result, the antenna is suitable for different applications requiring different antenna shapes and size.

FIG. 10 is a graph 1000 illustrating the return loss of a number of a various number of nested pentagons of an antenna radiator. More specifically, graph 1000 illustrates return loss versus frequency for nested pentagon-shaped radiators with five nested pentagons, four nested pentagons, three nested pentagons, two nested pentagons and a single pentagon, respectively. It can be seen from the figure that as the number of pentagons increases, the return loss of the antenna improves, especially at a lower end of the frequency range.

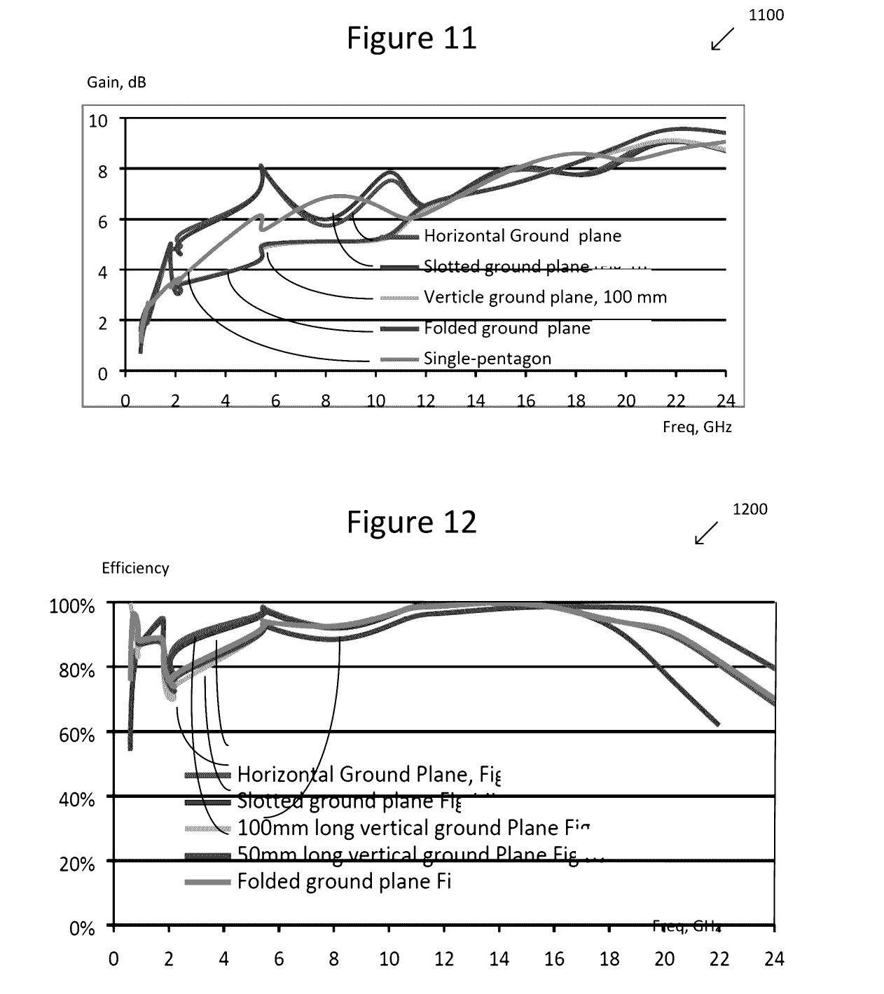

FIG. 11 is a graph 1100 illustrating the gain of various antenna configurations. More specifically, the graph 1100 illustrates maximum gain versus frequency for various antenna configurations including horizontal ground plane 20 (FIG. 1B), slotted ground plane 320 (FIG. 3), about 100 mm vertical ground plane 420 (FIG. 4), folded ground plane 620 (FIG. 6), and single pentagon radiator 210 (FIG. 2).

FIG. 12 is a graph 200 illustrating the efficiency of various antenna ground planes. More specifically, the graph 200 illustrates antenna efficiency versus frequency for antennas having various ground planes. The ground planes include horizontal ground plane 20 (FIG. 1B), slotted ground plane 320 (FIG. 3), about 100 mm vertical ground plane 420 (FIG. 4), about 50 mm vertical ground plane 520 (FIG. 5), and folded ground plane 620 (FIG. 6).

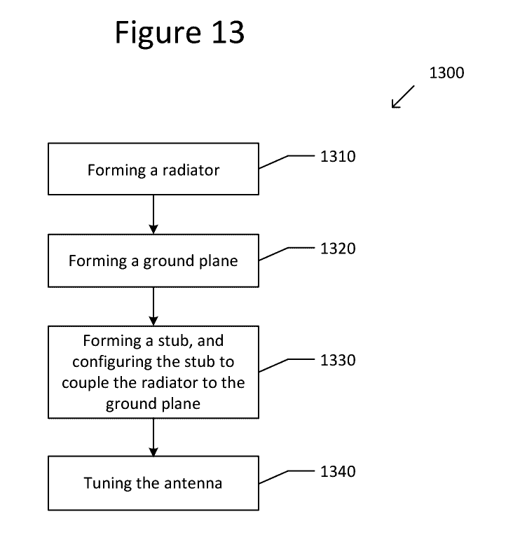

FIG. 13 is a flowchart illustrating a method 1300 of forming an antenna 100, 200, 300, 400, 500, 600.

At Step 1310, a radiator 110, 210, 310, 410, 510, 610 is formed.

At Step 1320, a ground plane 20, 220, 320, 420, 520, 620 is formed.

At Step 1330, a stub 130, 230, 330, 430, 530, 630 is formed and configured to couple the radiator 110, 210, 310, 410, 510, 610 to the ground plane 20, 220, 320, 420, 420, 620.

At Step 1340, the antenna 100, 200, 300, 400, 500, 600 is tuned. The antenna 100, 200, 300, 400, 500, 600 may be tuned by any known process.

Many of the known compact Ultra Wide Band (UWB) antennas have an operating frequency starting from about 2 GHz or above so as to focus on an application from about 3.1 GHz to about 10.6 GHz, which is the UWB Institute of Electrical and Electronics Engineers (IEEE) frequency band. The antenna disclosed herein is advantageous in that it is a super ultra wide band antenna that operates from about 680 MHz without compromising higher frequency performance. The antenna covers a super ultra wide frequency band from about 0.68 GHz to about 20 GHz in a small form factor. The antenna is thus suitable for devices that support multiple wireless technologies such as 2G, 3G, LTE, GPS, Wi-Fi, UWB, and many others which operate up to 20 GHz.

Also, the known antennas cannot have a change in size, which restricts their applications. The antenna disclosed herein, however, can have various ground plane configurations such as horizontal, slotted horizontal, vertical, reduced size vertical or foldable, thereby changing the shape and size of the antenna and increase the possible applications.

Example 1 is an antenna, comprising: a radiator; a ground plane; and a stub configured to couple the radiator to the ground plane.

In Example 2, the subject matter of Example 1, wherein the stub is substantially cylindrical in shape.

In Example 3, the subject matter of Example 1, wherein the radiator comprises a single pentagon-shaped radiator.

In Example 4, the subject matter of Example 3, wherein the stub is substantially cylindrical in shape and couples the ground plane to an outer point of the radiator.

In Example 5, the subject matter of Example 1, wherein the radiator comprises a plurality of nested pentagon-shaped radiators.

In Example 6, the subject matter of Example 5, wherein the substantially pentagon-shaped radiator comprises five nested pentagon-shaped radiators.

In Example 7, the subject matter of Example 1, wherein the radiator comprises a plurality of nested radiators.

In Example 8, the subject matter of Example 1, wherein the radiator is disposed at a right angle with respect to the ground plane.

In Example 9, the subject matter of Example 8, wherein the ground plane is a slotted ground plane.

In Example 10, the subject matter of Example 1, wherein the radiator and the ground plane are arranged in a same plane.

In Example 11, the subject matter of Example 10, wherein the ground plane is substantially square in shape, and the radiator and the ground plane have substantially the same diameter.

In Example 12, the subject matter of Example 10, wherein the ground plane is substantially rectangular in shape, and the smaller side of the substantially rectangular ground plane has a length that is less than the diameter of the radiator.

In Example 13, the subject matter of Example 1, wherein the ground plane is a folded ground plane.

In Example 14, the subject matter of Example 1, wherein the radiator, the ground plane or a combination of the radiator and the ground plane is formed on a Printed Circuit Board (PCB).

In Example 15, the subject matter of Example 1, wherein the antenna has an operating range from about 680 MHz to about 20 GHz.

Example 16 is a wireless communication device comprising the subject matter of Example claim 1.

In Example 17, the subject matter of Example 16, wherein the wireless communication device is selected from a group of devices consisting of a wireless router, wireless access point, and cellular gateway.

In Example 18, the subject matter of Example 17, wherein the cellular gateway is at least of a picocell, microcell, and femtocell gateway.

In Example 19, the subject matter of Example 17, wherein the wireless router is a Personal Area Network (PAN) router.

In Example 20 , the subject matter of Example 16, wherein the wireless communication device is operable for Long Term Evolution (LTE), Global Positioning System (GPS), ZigBee, Wi-Fi, and Ultra Wide Band (UWB).

In Example 21, the subject matter of Example 16, wherein the wireless communication device is operable for Microwave Impulse Radar (MIR).

Example 22 is a method of forming an antenna, comprising: forming a radiator; forming a ground plane; and forming a stub, and configuring the stub to couple the radiator to the ground plane.

In Example 23, the subject matter of Example 22, wherein forming the stub comprises forming a stub that is substantially cylindrical in shape.

In Example 24, the subject matter of Example 22, further comprising: tuning the antenna.

In Example 25, the subject matter of any of Examples 1-2, wherein the radiator comprises a single pentagon-shaped radiator.

In Example 26, the subject matter of any of Examples 1-3, wherein the stub is substantially cylindrical in shape and couples the ground plane to an outer point of the radiator.

In Example 27, the subject matter of any of Examples 1-2, wherein the radiator comprises a plurality of nested pentagon-shaped radiators.

In Example 28, the subject matter of any of Examples 1-2, wherein the radiator comprises a plurality of nested radiators.

In Example 29, the subject matter of any of Examples 1-7, wherein the radiator is disposed at a right angle with respect to the ground plane.

In Example 30, the subject matter of any of Examples 1-7, wherein the radiator and the ground plane are arranged in a same plane.

In Example 31, the subject matter of any of Examples 1-7, wherein the ground plane is a folded ground plane.

In Example 32, the subject matter of any of Examples 1-13, wherein the radiator, the ground plane or a combination of the radiator and the ground plane is formed on a Printed Circuit Board (PCB).

In Example 33, the subject matter of any of Examples 1-14, wherein the antenna has an operating range from about 680 MHz to about 20 GHz.

Example 34 is a wireless communication device comprising the subject matter of any of Examples 1-15.

In Example 35, the subject matter of any of Examples 22-23, further comprising: tuning the antenna.

Example 36 is an apparatus substantially as shown and described.

Example 37 is a method substantially as shown and described.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. An antenna, comprising:
a radiator;
a ground plane; and
a stub configured to couple the radiator to the ground plane.

2. The antenna of claim 1, wherein the stub is substantially cylindrical in shape.

3. The antenna of claim 1, wherein the radiator comprises a single pentagon-shaped radiator.

4. The antenna of claim 3, wherein the stub is substantially cylindrical in shape and couples the ground plane to an outer point of the radiator.

5. The antenna of claim 1, wherein the radiator comprises a plurality of nested pentagon-shaped radiators.

6. The antenna of claim 5, wherein the substantially pentagon-shaped radiator comprises five nested pentagon-shaped radiators.

7. The antenna of claim 1, wherein the radiator comprises a plurality of nested radiators.

8. The antenna of claim 1, wherein the radiator is disposed at a right angle with respect to the ground plane.

9. The antenna of claim 8, wherein the ground plane is a slotted ground plane.

10. The antenna of claim 1, wherein the radiator and the ground plane are arranged in a same plane.

11. The antenna of claim 10, wherein the ground plane is substantially square in shape, and the radiator and the ground plane have substantially the same diameter.

12. The antenna of claim 10, wherein the ground plane is substantially rectangular in shape, and the smaller side of the substantially rectangular ground plane has a length that is less than the diameter of the radiator.

13. The antenna of claim 1, wherein the ground plane is a folded ground plane.

14. The antenna of claim 1, wherein the radiator, the ground plane or a combination of the radiator and the ground plane is formed on a Printed Circuit Board (PCB).

15. The antenna of claim 1, wherein the antenna has an operating range from about 680 MHz to about 20 GHz.

16. A wireless communication device comprising the antenna of claim 1.

17. The wireless communication device of claim 16, wherein the wireless communication device is selected from a group of devices consisting of a wireless router, wireless access point, and cellular gateway.

18. The wireless communication device of claim 17, wherein the cellular gateway is at least of a picocell, microcell, and femtocell gateway.

19. The wireless communication device of claim 17, wherein the wireless router is a Personal Area Network (PAN) router.

20. The wireless communication device of claim 16, wherein the wireless communication device is operable for Long Term Evolution (LTE), Global Positioning System (GPS), ZigBee, Wi-Fi, and Ultra Wide Band (UWB).

21. The wireless communication device of claim 16, wherein the wireless communication device is operable for Microwave Impulse Radar (MIR).

22. A method of forming an antenna, comprising:
forming a radiator;
forming a ground plane; and
forming a stub, and configuring the stub to couple the radiator to the ground plane.

23. The method claim 22, wherein forming the stub comprises forming a stub that is substantially cylindrical in shape.

24. The method of claim 22, further comprising:
tuning the antenna.
